(19) United States
(12) Patent Application Publication
(10) Pub. No.: US 2024/0394851 A1
(43) Pub. Date: Nov. 28, 2024

(54) TEMPORAL COMPOSITIONAL DENOISING

(71) Applicants: Disney Enterprises, Inc., Burbank, CA (US); ETH Zürich (Eidgenössische Technische Hochschule Zürich), Zürich (CH)

(72) Inventors: Marios PAPAS, Opfikon (CH); Gerhard ROTHLIN, Horw (CH); Marco MANZI, Zürich (CH); Xianyao ZHANG, Zürich (CH)

(21) Appl. No.: 18/673,964

(22) Filed: May 24, 2024

Related U.S. Application Data
(60) Provisional application No. 63/504,421, filed on May 25, 2023.

(51) Int. Cl. G06T 5/70; G06T 5/60

(52) U.S. Cl. CPC G06T 5/70; G06T 5/60; G06T 2207/10016; G06T 2207/20084

(57) ABSTRACT

One embodiment of the present invention sets forth a technique for denoising video content. The technique includes converting a first frame into a first set of learned components. The technique also includes converting one or more frames that are temporally related to the first frame into one or more additional sets of learned components. The technique further includes generating, via a first machine learning model, a denoised frame corresponding to the first frame based on the first set of learned components and the one or more additional sets of learned components.

### CROSS-REFERENCE TO RELATED APPLICATIONS

This application claims the benefit of the U.S. Provisional Application titled “TEMPORAL COMPOSITIONAL DENOISING,” filed on May 25, 2023, and having Ser. No. 63/504,421. The subject matter of this application is hereby incorporated herein by reference in its entirety.

### BACKGROUND

### Field of the Various Embodiments

Embodiments of the present disclosure relate generally to video denoising and, more specifically, to temporal compositional denoising of video.

### DESCRIPTION OF THE RELATED ART

Animated movies, visual effects, video games, simulations, three-dimensional (3D) designs, and other computer graphics applications rely on rendering to simulate light transport in a 3D scene. One common rendering technique is path tracing, which involves tracing light paths from a light source as corresponding rays of light bounce around the scene before arriving at a camera. For example, a path tracing procedure may cast rays of light from the camera into the 3D scene. As a given ray of light intersects an object or medium, the ray may be absorbed, reflected, or refracted, and new rays of light may be traced from these interaction points. This process may be repeated multiple times for each pixel of a rendered image, with each path contributing a sample of light to the rendered image based on the materials and light sources encountered along the path. Path tracing uses Monte Carlo techniques to randomly sample these light paths, which allows for the simulation of complex optical effects such as soft shadows, depth of field, motion blur, indirect lighting, caustics, and global illumination.

However, because path tracing relies on random sampling, the number of samples required to accurately capture light transport in a scene is typically prohibitively expensive with respect to resource consumption. For example, a single frame of a rendered movie may include around 8 million pixels and be rendered using hundreds of rays per pixel, which would require hundreds of hours of compute on a single machine. Instead, to make Monte Carlo rendering feasible for movie productions and/or other real-world applications, a smaller number of samples is used to render a given frame, which results in noise that appears as graininess and/or specks within the rendered frame. A denoising technique can then be used to remove noise from the noisy rendered frame with a resource overhead that is a fraction of that associated with the computationally intensive rendering process.

Traditional approaches to removing noise from images typically use computer vision techniques to analyze the spatial and frequency content of the images. These techniques often involve the use of kernels to compute the color of a pixel as a weighted average of noisy estimates of neighboring pixel colors. More recently, machine learning models have been trained on large datasets of pairs of noisy and clean images to learn complex transformations that map the noisy input images to clean output images. After training is complete, these machine learning models can be used to predict kernels that are used to filter noisy pixel estimates. These machine learning models can also, or instead, be used to directly predict the pixel values of a denoised image from input that includes a noisy version of the image.

One type of denoising machine learning model decomposes a noisy input image into multiple additive components that are individually easier to denoise than the input image. Each component can then be denoised independently using kernels predicted by a denoiser, and the final denoised image is produced by summing all denoised components outputted by the denoiser. While this decomposition-based approach improves the quality of still-image denoising compared to other techniques, this approach does not account for temporal information across sequences of temporally related frames (e.g., in a video), which can lead to flickering and/or other artifacts in the denoised output.

As the foregoing illustrates, what is needed in the art are more effective techniques for denoising sequences of temporally related frames.

### SUMMARY

One embodiment of the present invention sets forth a technique for denoising video content. The technique includes converting a first frame into a first set of learned components. The technique also includes converting one or more frames that are temporally related to the first frame into one or more additional sets of learned components. The technique further includes generating, via a first machine learning model, a denoised frame corresponding to the first frame based on the first set of learned components and the one or more additional sets of learned components.

One technical advantage of the disclosed techniques relative to the prior art is the ability to denoise video sequences in a way that leverages both temporal information across multiple frames of video and a decomposition of each frame into multiple additive components. Consequently, the disclosed techniques reduce flickering and artifacts in denoised video content, compared with conventional techniques that perform denoising of individual frames. The disclosed techniques additionally improve denoising quality and/or reduce the amount of rendering required to achieve a certain rendering quality, compared to conventional approaches for performing temporal denoising of video. Another technical advantage of the disclosed techniques is a reduction in resource consumption and/or runtime through the use of optimization techniques that cache and reuse previously computed learned components during denoising of additional frames and/or quantize cached data that is used across rendering passes. Accordingly, the disclosed techniques improve the usability of the temporal compositional denoising process in real-world and/or resource-constrained applications without sacrificing the quality of the denoised video. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of various embodiments.

FIG. 2 is a more detailed illustration of the training engine and execution engine of FIG. 1, according to various embodiments.

FIG. 3 illustrates how the decomposition module and denoising module of FIG. 2 are used to generate a denoised frame from a sequence of noisy input frames, according to various embodiments.

FIG. 4 is a flow diagram of method steps for performing temporal compositional denoising, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

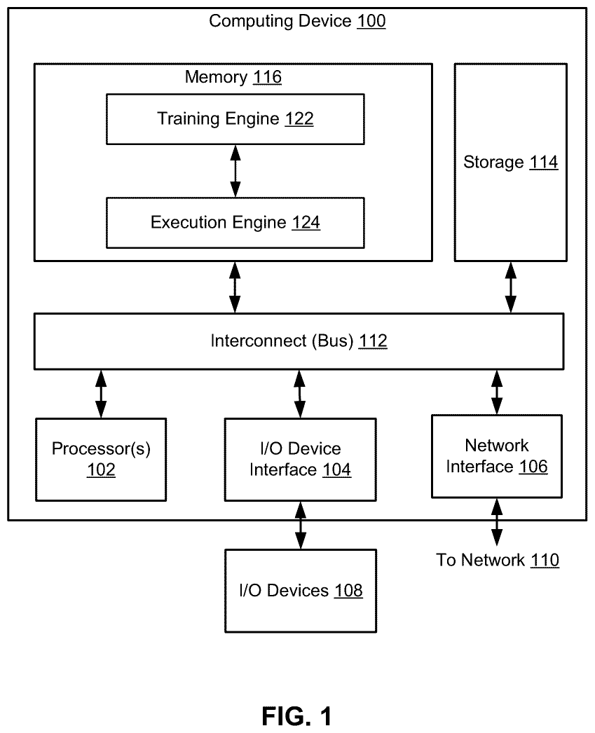

FIG. 1 illustrates a computing device 100 configured to implement one or more aspects of various embodiments. In one embodiment, computing device 100 includes a desktop computer, a laptop computer, a smartphone, a personal digital assistant (PDA), a tablet computer, or any other type of computing device configured to receive input, process data, and optionally display images, and is suitable for practicing one or more embodiments. Computing device 100 is configured to run a training engine 122 and execution engine 124 that reside in a memory 116.

It is noted that the computing device described herein is illustrative and that any other technically feasible configurations fall within the scope of the present disclosure. For example, multiple instances of training engine 122 and execution engine 124 could execute on a set of nodes in a distributed and/or cloud computing system to implement the functionality of computing device 100. In another example, training engine 122 and execution engine 124 could execute on various sets of hardware, types of devices, or environments to adapt to different use cases or applications. In a third example, training engine 122 and execution engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) and/or a virtual computing instance executing within a computing cloud.

I/O devices 108 include devices capable of providing input, such as a keyboard, a mouse, a touch-sensitive screen, a microphone, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Training engine 122 and execution engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 and execution engine 124.

Training engine 122 and execution engine 124 include functionality to train and execute one or more machine learning models in a temporal compositional denoising task, in which a decomposition of a sequence of noisy frames is used to generate a denoised version of one of the frames in the sequence. The machine learning model(s) include a decomposition module that converts each frame in the sequence into multiple learned components. The machine learning model(s) also include a denoising module that predicts kernels that can be used to denoise each component of a single frame in the sequence, given input that includes that component for the single frame and additional corresponding components for other frames in the sequence. The denoised components for the frame can then be combined into a denoised version of the single frame.

As described in further detail below, the temporal compositional denoising technique provided by training engine 122 and execution engine 124 improves the quality and temporal consistency of denoised output across sequences of temporally related frames. The temporal compositional denoising technique can also be implemented using optimizations that reduce memory consumption, computational runtime, and/or resource overhead, thereby allowing training engine 122 and execution engine 124 to be used in a real-world production environment.

### Temporal Compositional Denoising

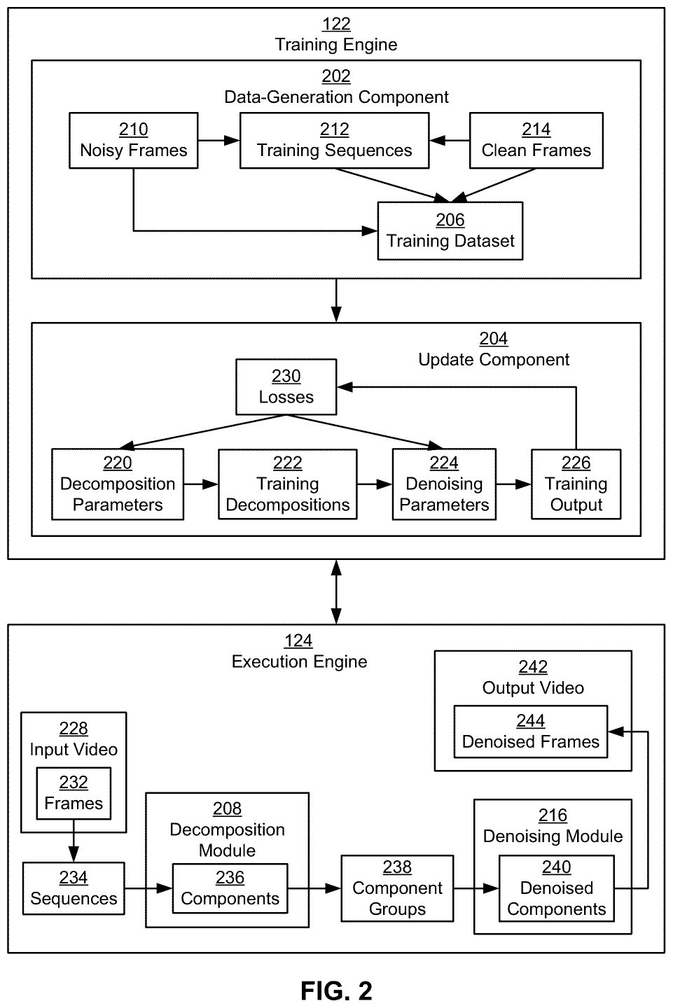

FIG. 2 is a more detailed illustration of training engine 122 and execution engine 124 of FIG. 1, according to various embodiments. As mentioned above, training engine 122 and execution engine 124 operate to train and execute a set of machine learning models that perform temporal compositional denoising of some or all frames 232 in an input video 228. The machine learning models include a decomposition module 208 and a denoising module 216. Each of these components is described in further detail below.

Input into decomposition module 208 includes sequences 234 of frames 232 extracted from an input video 228. In some embodiments, input video 228 includes frames 232 of rendered content that depict a three-dimensional (3D) scene. Input video 228 may also, or instead, include content that is captured by a camera and/or another type of sensor. Within input video 228, one or more subsets of contiguous and/or non-contiguous frames 232 in input video 228 can be temporally related. For example, temporally related subsets of frames 232 within input video 228 may correspond to individual shots, animations, sequences of motion, and/or other temporally consistent representations of changes to the 3D scene over time (e.g., as a part of a game, virtual world, television show, movie, etc.).

A given subset of temporally related frames 232 in input video 228 can additionally be divided into multiple overlapping sequences 234 of frames 232, where a given sequence includes a single frame to be denoised, one or more frames preceding the single frame within input video 228, and/or one or more frames 232 succeeding the single frame within input video 228. For example, execution engine 124 may convert a longer sequence of Y temporally related frames 232 in input video 228 into Y shorter sequences of length 2N+1, whereK>=2N+1. Each sequence of length 2N+1 may include a different frame to be denoised in the “middle” of the sequence, N frames preceding the middle frame from the longer sequence of Y frames, and N frames succeeding the single frame from the longer sequence of Y frames. When a given middle frame is less than N frames from the beginning or end of the longer sequence of Y frames, black and/or empty frames may be included in positions within the corresponding sequence of 2N+1 frames 232 that fall outside the longer sequence of Y frames. Thus, a sequence of length 2N+1 with a middle frame that corresponds to the first frame in the sequence of Y temporally related frames may include N black and/or empty frames that precede the middle frame, a sequence of 2N+1 frames 232 with a middle frame that corresponds to the second frame in the sequence of Y temporally related frames may include N−1 black and/or empty frames followed by the first frame in the sequence of Y temporally related frames prior to the middle frame, and so on.

Decomposition module 208 converts individual frames 232 from each of sequences 234 into corresponding sets of learned components 236. For example, a given input into decomposition module 208 may include a single noisy frame from a given sequence of frames 232, as well as additional feature maps associated with the frame. These feature maps may include surface normals, albedo maps, depth maps, variance estimates of pixel colors and/or other features, and/or other information that is used to render the frame and/or learned by a neural network.

Decomposition module 208 includes a U-Net, convolutional neural network (CNN), and/or another type of machine learning model that decomposes input data for a corresponding frame into multiple additive components 236. For example, let x=[c, f] denote the concatenation of noisy pixel colors c and feature maps f that are used as input into decomposition module 208 for a corresponding frame. Decomposition module 208 may convert the input into a set of non-negative components 236 {c^{(k)}}ₖ₌₁^{K} that sum to c. This decomposition may also be defined by a set of masks {m^{(k)}}_{k=1′}^{K}, such that c^{(k)}=c ⊙m^{(k)}, where ⊙ denotes the per-element multiplication operator. To ensure non-negativity of components 236, the masks may also follow the convex constraint for each pixel p:

$${\sum }_{k = 1}^{K} {m}_{p}^{( k )} = 1 and 0 \leq {m}_{p}^{( k )} \leq 1 , ∀ k = 1 … K \qquad ( 1 )$$

Continuing with the above example, decomposition module 208 may include a trainable decomposition function h that corresponds to a CNN with trainable parameters ϕ. In response to input that includes an image c and a feature map f, decomposition module 208 may output a mask m that includes values in the range of [0,1] and two feature maps (one per output component):

$$h ( c , f ; ϕ ) = \{ m , {f}^{( 0 )} , {f}^{( 1 )} \} \qquad ( 2 )$$

The mask m and input image c may have the same number of image channels (e.g., three channels corresponding to RGB triplets).

Element-wise multiplication of the mask (and its complement) with the input image splits the input into two components:

$${c}^{( 0 )} = m ⊙ c \qquad ( 3 )$$

$${c}^{( 1 )} = ( 1 - m ) ⊙ c \qquad ( 4 )$$

where c⁽⁰⁾+c⁽¹⁾=c. The two component-feature pairs {c⁽⁰⁾, f⁽⁰⁾} and {c⁽¹⁾, f⁽¹⁾} are the output of decomposition module 208.

In some embodiments, decomposition module 208 is concatenated hierarchically to decompose individual frames 232 into more than two components 236. For example, decomposition module 208 may be used to perform an initial decomposition of a given frame into two components 236. Decomposition module 208 may then be used to further decompose each component into two additional components 236 to produce a total of four components 236. The process may be repeated with a given component and/or set of components 236 to generate additional an arbitrary number of components 236 that is greater than two for the frame. In other embodiments, decomposition module 208 is configured to decompose a given frame 232 and/or an existing component 236 of a given frame 232 into more than two components 236.

After a given sequence of frames 232 is decomposed into corresponding components 236 by decomposition module 208, these components 236 are rearranged into multiple component groups 238. In one or more embodiments, each component group includes a single component from each frame in the sequence, and all components 236 in the same component group are associated with the same “type” of component. Continuing with the above example, the four components 236 into which a given frame is decomposed may be indexed numerically from 1 to 4. Components 236 with indexes of 1 and 2 may correspond to the two components into which the first component from the initial decomposition is decomposed. Components 236 with indexes of 3 and 4 may correspond to the two components into which the second component from the initial decomposition is decomposed. Thus, component groups 238 may include a first component group that includes components 236 with indexes of 1 for all frames 232 in the sequence, a second component group that includes components 236 with indexes of 2 for all frames 232 in the sequence, a third component group that includes components 236 with indexes of 3 for all frames 232 in the sequence, and a fourth component group that includes components 236 with indexes of 4 for all frames 232 in the sequence.

Denoising module 216 converts individual component groups 238 into corresponding denoised components 240. Continuing with the above example, denoising module 216 may convert each of the four component groups 238 into a single denoised component with the same index as the set of components 236 in the component group. This single denoised component may correspond to the same “type” as the set of components 236 in the component group.

In one or more embodiments, denoising module 216 includes a U-Net, kernel predicting convolutional network (KPCN), and/or another type of machine learning model that generates per-pixel kernels associated with a noisy component from a frame to be denoised, given input that includes multiple components from a certain component group associated with the “type” of the noisy component. The per-pixel kernels can then be applied to corresponding pixel values of the noisy component to generate a corresponding denoised component. The process can be repeated for additional component groups to generate multiple denoised components corresponding to multiple noisy components from each frame to be denoised.

In some embodiments, denoising module 216 generates per-pixel kernels at multiple scales and/or resolutions associated with a given noisy component 236. For example, denoising module 216 may generate, for a given pixel in that noisy component 236, multiple smaller denoising kernels 306 at multiple corresponding resolutions to capture noise patterns at different frequencies, in lieu or instead of predicting a single denoising kernel per pixel of that noisy component 236.

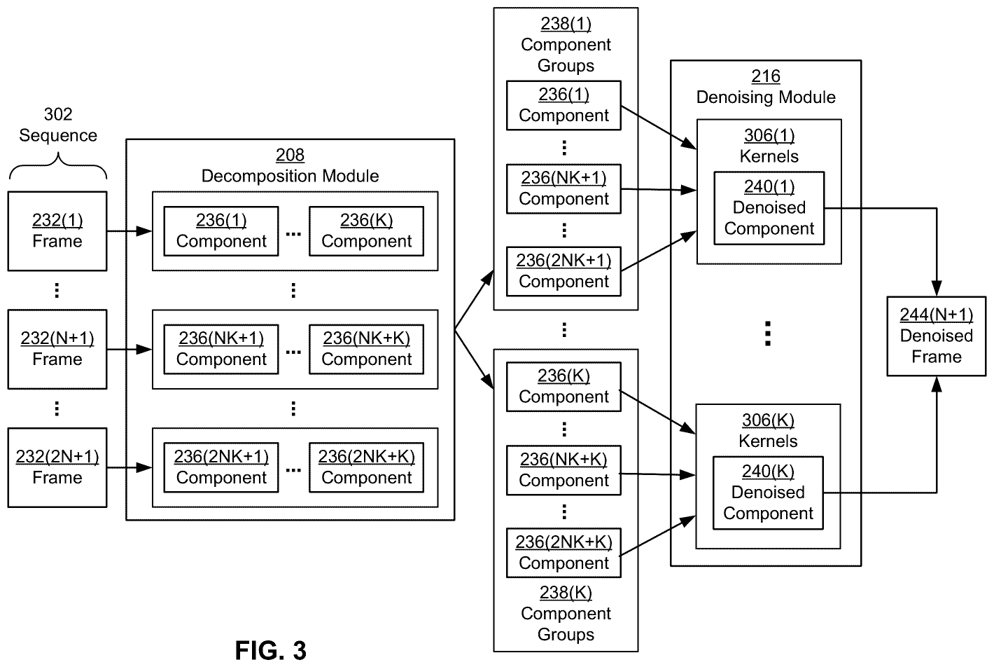

After denoised components 240 associated with a noisy frame from input video 228 are outputted by denoising module 216, a denoised frame corresponding to the noisy frame is constructed from these denoised components 240. For example, execution engine 124 may sum and/or otherwise combine these denoised components 240 into the denoised frame. Execution engine 124 may repeat the process to convert remaining frames 232 in input video 228 into corresponding denoised frames 244. The operation of decomposition module 208 and denoising module 216 is described in further detail below with respect to FIG. 3.

After noisy frames 232 from input video 228 have been converted into corresponding denoised frames 244, execution engine 124 assembles denoised frames 244 into an output video 242. For example, execution engine 124 may order denoised frames 244 within output video 242 in a manner that reflects the ordering of the corresponding noisy frames 232 within input video 228.

FIG. 3 illustrates how decomposition module 208 and denoising module 216 of FIG. 2 are used to generate a denoised frame 244(N+1) from a sequence 302 of noisy input frames 232(1)-232(2N+1), according to various embodiments. As shown in FIG. 3, the sequence 302 includes a starting frame 232(1), an ending frame 232(2N+1), and a middle frame 232(N+1) that lies between the starting frame 232(1) and ending frame 232(2N+1) and is to be denoised using sequence 302. Each of frames 232(1), 232(N+1), and 232(2N+1) is referred to individually herein as frame 232. The sequence 302 can include additional frames 232 (not shown) between the starting frame 232(1) and the middle frame 232(N+1) and/or between the ending frame 232(N+1) and the ending frame 232(2N+1).

Decomposition module 208 performs a decomposition of each frame 232 into multiple learned components. More specifically, decomposition module 208 decomposes frames 232(1), 232(N+1), and 232(2N+1) into different sets of components 236(1)-236(K), 236(N+1)-236(2N+1), and 236(2NK+1)-236(2NK+K), respectively (each of which is referred to individually herein as component 236), as discussed above.

Components 236 associated with individual frames 232 are then regrouped into multiple component groups 238(1)-238(K) (each of which is referred to individually herein as component group 238). As mentioned above, each component group 238 can represent one “type” of component and include a component 236 of that type from each frame 232. For example, a set of K components 236 (where K is a positive integer) associated with each frame 232 may be numerically indexed, so that the first component 236 for that frame 232 has an index of 1 and the last component 236 for that frame 232 has an index of K. The first component group 238(1) may thus include components 236 with indexes of 1 from all frames 232, and the last component group 238(K) may include components 236 with indexes of K from all frames 232.

In some embodiments, one or more components 236 within a given component group 238 are warped according to motion vectors associated with the respective frames 232. For example, optical flow and/or motion estimation techniques may be used to determine motion vectors between pixels representing certain types of content (e.g., objects, textures, etc.) within frame 232(N+1) and pixels that represent the same types of content within other frames 232 in sequence 302. These motion vectors may then be used to warp pixels in components 236 within each component group 238 that are not associated with frame 232(N+1), so that pixels that correspond to the same type of content in components 236 within a given component group 238 are spatially aligned with one another.

Each component group 238 is processed separately by denoising module 216 to generate a different set of per-pixel kernels 306(1)-306(K) (each of which is referred to individually herein as kernels 306) for each component 236(1)-236(K) in the middle frame 232. These per-pixel kernels 306(1)-306(K) are then applied to pixel values in the corresponding component 236(1)-236(K) to generate a corresponding denoised component 240(1)-240(K) (each of which is referred to individually herein as denoised component 240). Denoised components 240 can then be summed and/or combined into denoised frame 244(N+1) corresponding to frame 232(N+1).

In one or more embodiments, the generation of denoised frame 244(N+1) is represented by the following:

$${d}_{p} = {g}_{p} ( {x}_{comp} ; θ ) = {\sum }_{k = 1}^{K} {g}_{p}^{( k )} ( {x}_{comp}^{( k )} ; {θ}^{( k )} ) , {x}_{comp}^{( k )} = [ {c}_{comp}^{( k )} , {f}_{comp}^{( k )} ] \qquad ( 5 )$$

In the above equation, dₚ represents the value of pixel p in denoised frame 244(N+1), which is generated as a summation of K denoised components 240(1)-240(K) from denoising module 216 for that pixel. The operation of denoising module 216 in generating the kth denoised component is represented by gₚ^{(k)} and is based on input that includes a kth component group 238 x_{comp}^{(k)}. The kth component group 238 includes multiple sets of pixel values c_{comp}^{(k)}, and feature maps f_{comp}^{(k)} for components 236 in that component group 238. Additionally, each denoised component 240 can be generated using a separate instance of denoising module 216 with corresponding parameters θ^{(k)}, or a single instance of denoising module 216 can be used to generate multiple denoised components 240.

The kth denoised component of pixel p d_{q}^{(k)} can be computed as a weighted sum of neighboring pixel values c_{q}^{(k)} within an l×l neighborhood [symbol] (p) from the kth noisy component 236 of the frame to be denoised:

$${d}_{q}^{( k )} = {g}_{p}^{( k )} ( {x}_{comp}^{( k )} ; {θ}^{( k )} ) = {\sum }_{q ∈ 𝒩 ( p )} {w}_{pq}^{( k )} ( {x}_{comp}^{( k )} ; {θ}^{( k )} ) {c}_{q}^{( k )} \qquad ( 6 )$$

In the above equation, weights w_{pq}^{(k)} correspond to kernels 306 predicted by denoising module 216 gₚ for the pixel based on an inputted component group 238 x_{comp}^{(k)}.

In some embodiments, multiple passes are performed by decomposition module 208 and denoising module 216 using different types of data and/or layers associated with frames 232 to generate multiple denoised versions of denoised frame 244(N+1) for a single frame 232(N+1) to be denoised. These versions of denoised frame 244(N+1) can then be composited and/or otherwise combined into a final denoised frame 244(N+1) corresponding to the original noisy frame 232(N+1). For example, frames 232 in sequence 302 may be divided into multiple layers storing different types of data (e.g., diffuse, specular, alpha, foreground, background, types of objects, shapes, contours, haze layers, textures, light sources, types of illumination, etc.). Each layer and/or type of data may be processed in a separate pass by decomposition module 208 and denoising module 216 to generate a separate set of components 236, component groups 238, kernels 306, denoised components 240, and version of denoised frame 244(N+1). The version of denoised frame 244(N+1) outputted by a given pass may correspond to the denoising of a certain type of data within the original noisy frame 232(N+1). After all types of data have been converted into corresponding versions of denoised frame 244(N+1), these versions of denoised frame 244(N+1) can be composited, blended, and/or otherwise combined into a final version of denoised frame 244(N+1).

Additionally, multiple instances of decomposition module 208 and denoising module 216 can be used to perform multiple rounds of decomposition and/or denoising associated with a given sequence 302 of frames 232. For example, each instance of decomposition module 208 in a hierarchy may be followed by a corresponding instance of denoising module 216 to perform multiple rounds of decomposition and denoising for a given sequence 302 of frames 232. In this example, each round of decomposition and denoising may be applied to a different set of components 236 associated with frames 232. In another example, components 236 generated by a given instance of decomposition module 208 may be denoised using one or more instances of denoising module 216. In a third example, a given instance of denoising module 216 may be used to denoise components 236 generated by one or more instances of decomposition module 208.

In one or more embodiments, decomposition module 208 and denoising module 216 include functionality to incorporate various optimizations during decomposition and/or denoising of frames 232. These optimizations can reduce memory usage, computational overhead, and/or runtime associated with denoising individual frames 232.

One optimization involves warping components 236 within component groups 238 instead of warping frames 232 prior to decomposition. This delayed warping allows components 236 to be cached and reused in the denoising of other frames 232 in sequence 302 instead of requiring components 236 to be recomputed for all frames 232 in a given sequence 302. For example, after denoising of frame 232(N+1) is complete, the process may be repeated with the next frame 232(N+2) using a corresponding new sequence 302 of frames 232(2)-232(2N+2). During denoising of this next frame 232(N+2), components 236 that were previously computed by decomposition module 208 for frames 232(2) to 232(2N+1) during denoising of frame 232(N+1) may be retrieved from a cache instead of recomputed, and only frame 232(2N+2) may be converted into a corresponding set of components 236 by decomposition module 208. These components 236 may then be arranged into component groups 238, warped using motion vectors between frame 232(2N+2) and the other frames 232 in the new sequence 302, and used by denoising module 216 to generate kernels 306, denoised components 240, and a new denoised frame 244(N+2) corresponding to the original noisy frame 232(N+2).

This caching and reuse of components 236 across frames 232 to be denoised can significantly reduce the runtime and/or computational overhead of the temporal compositional denoising process, compared with a naïve approach that computes components 236 for all frames 232 in a given sequence 302 during a corresponding denoising pass. For example, caching and reuse of components 236 may reduce denoising time by 60-70% for a sequence 302 of seven frames 232 that is used to denoise a middle (i.e., fourth) frame in that sequence 302, compared with the naïve approach.

Another optimization involves quantizing tensors associated with components 236, kernel 306 weights (e.g., for use in denoising multiple per-light noisy images and/or other types of data associated with a given frame 232), multi-scale reconstruction weights, intra-network tensors, and/or other data that is cached for subsequent reuse. For example, each tensor may have a shape denoted byH×W×C, where H represents height, W represents width, and C represents a number of channels. A given channel of shapeH×W may be quantized by storing the minimum and maximum values of the channel as 32-bit floats, normalizing the channel to the range of [−1, 1] using the minimum and maximum values, and converting the normalized tensor into 8-bit integers. For certain types of data (e.g., kernel 306 weights, per-component noisy images, etc.), a gamma curve

$$f ( x ) = {x}^{\frac{1}{2.5}}$$

may be applied before normalization to compress the dynamic range of the data and reduce the impact of outliers on quantization results.

Quantization of cached data can reduce the memory consumption of the temporal compositional denoising process by more than 50%. For example, quantization of cached kernels 306, multi-scale reconstruction weights, and components 236 may reduce the memory usage associated with the cached data by a factor of 4 and reduce peak memory usage for a seven-frame sequence 302 of three-channel 2560×1400 images from 124.9 GiB to 59.8 GiB. This reduction in memory consumption may additionally allow temporal compositional denoising at this resolution to be performed on machines with 64 GiB of memory.

Returning to the discussion of FIG. 2, training engine 122 trains decomposition module 208 and denoising module 216 using a training dataset 206 that includes noisy frames 210 of video and corresponding clean frames 214 of video. Noisy frames 210 include one or more sequences of temporally related noisy video frames, and clean frames 214 include non-noisy versions of noisy frames 210. For example, noisy frames 210 may include frames of video that have been rendered using a certain number of light samples, and clean frames 214 may include some or all of the same frames that have been rendered using a large number of light samples. In another example, noisy frames 210 may include frames of video with rendering noise, and clean frames 214 may include denoised versions of the frames that are generated using another denoising technique.

A data-generation component 202 in training engine 122 divides noisy frames 210 into discrete training sequences 212 and pairs training sequences 212 with clean frames 214 to form a training dataset 206. For example, data-generation component 202 may divide a longer sequence of temporally related noisy frames 210 into shorter training sequences 212 of a certain length, where each training sequence includes a corresponding noisy frame from the longer sequence to be denoised. Additional frames in a given training sequence may include frames from the longer sequence that precede and/or succeed the noisy frame to be denoised and/or frames that are black and/or blank to act as placeholders for the corresponding positions in the training sequence, as discussed above. Data-generation component 202 may also generate training dataset 206 by storing each training sequence with (i) an identifier for and/or location of a given noisy frame within the training sequence to be denoised and (ii) an identifier for and/or location of a ground truth clean frame for the noisy frame.

Training engine 122 also includes an update component 204 that uses decomposition parameters 220 of decomposition module 208 to convert noisy frames 210 in each of training sequences 212 into training decompositions 222 that include multiple components per noisy frame. Update component 204 inputs training decompositions 222 into denoising module 216 and uses denoising parameters 224 of denoising module 216 to convert training decompositions into training output 226. Training output 226 includes predictions of denoised frames corresponding to noisy frames to be denoised within training sequences 212. Update component 204 computes one or more losses 230 between each training output 226 generated from noisy frames 210 included in a training sequence and a corresponding ground truth clean frame that is paired with the training sequence. Update component 204 also uses the computed losses 230 to update decomposition parameters 220 and denoising parameters 224.

In one or more embodiments, update component 204 computes losses 230 using the following per-pixel representation:

$$ℓ ( {r}_{p} , {d}_{p} ) = \frac{\vert {r}_{p} - {d}_{p} \vert}{\vert {r}_{p} \vert + \vert {d}_{p} \vert + ε} , ε = 1 {0}^{- 2} \qquad ( 7 )$$

In the above equation, a loss [symbol] is computed based on a pixel value rₚ from a clean frame and a pixel value dₚ from training output 226 generated by decomposition module 208 and denoising module 216 from an inputted training sequence 212 that is paired with the clean frame. The loss corresponds to a symmetric mean absolute percentage error (SMAPE).

In some embodiments, update component 204 trains decomposition module 208 and denoising module 216 in an end-to-end fashion using losses 230. For example, after losses 230 are computed for a given set of training examples from training dataset 206, update component 204 may backpropagate losses 230 across denoising parameters 224 and decomposition parameters 220. Update component 204 may also use stochastic gradient descent to update denoising parameters 224 and decomposition parameters 220 based on the negative gradients of the backpropagated losses. Update component 204 may repeat the training process until a certain number of training steps, iterations, batches, and/or epochs has been performed; losses 230 fall below a threshold; denoising parameters 224 and/or decomposition parameters 220 converge; and/or another condition is met. After training of decomposition module 208 and denoising module 216 is complete, execution engine 124 can use decomposition module 208 and denoising module 216 to convert additional noisy frames 232 of input video 228 into corresponding denoised frames 244, as discussed above.

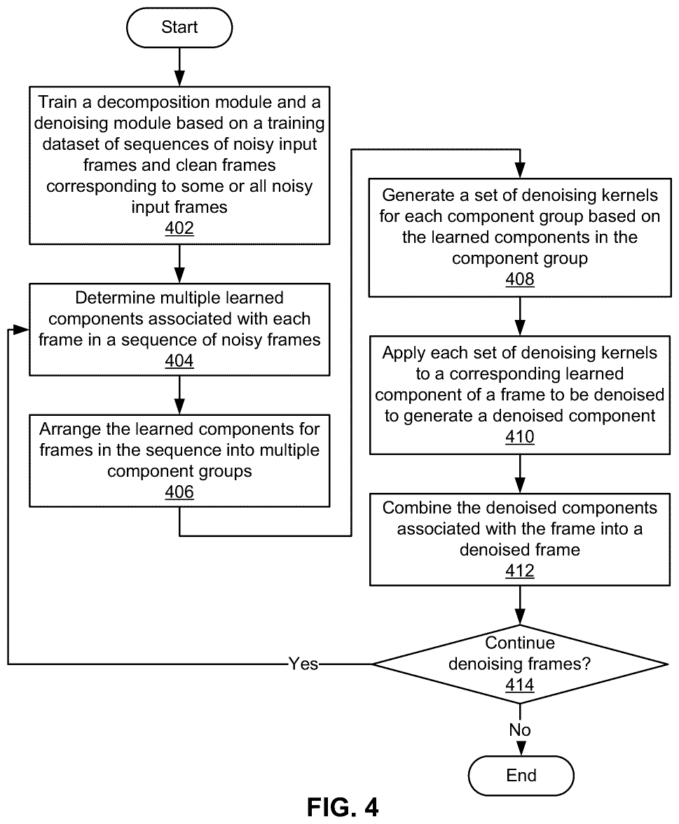

FIG. 4 is a flow diagram of method steps for performing temporal compositional denoising, according to various embodiments. Although the method steps are described in conjunction with the systems of FIGS. 1-2, persons skilled in the art will understand that any system configured to perform the method steps in any order falls within the scope of the present disclosure.

As shown, in step 402, training engine 122 trains a decomposition module and a denoising module based on a training dataset of sequences of noisy input frames and clean frames corresponding to some or all of the noisy input frames. For example, training engine 122 may train the decomposition module and denoising module to learn a transformation between each sequence of noisy input frames and a single clean frame that corresponds to a non-noisy version of one noisy input frame in the sequence.

In step 404, execution engine 124 determines multiple learned components associated with each frame in a sequence of noisy frames. For example, execution engine 124 may use the trained decomposition module in an iterative and/or hierarchical manner to convert pixel values and/or feature maps associated with each frame into a set of learned components. Each learned component may include a set of pixel values, a mask, and/or a set of learned features.

In step 406, execution engine 124 arranges the learned components for frames in the sequence into multiple component groups. For example, execution engine 124 may add a certain “type” of learned component associated with each frame into a corresponding component group. Execution engine 124 may also warp one or more components in a component group using motion vectors between a frame in the sequence to be denoised and remaining frames in the sequence.

In step 408, execution engine 124 generates a set of denoising kernels for each component group based on the learned components in the component group. For example, execution engine 124 may use the trained denoising module to predict per-pixel kernels for a component of the frame to be denoised, given input that includes the component and warped components for other frames from the same component group.

In step 410, execution engine 124 applies each set of denoising kernels to a corresponding learned component of the frame to be denoised to generate a denoised component. Continuing with the above example, execution engine 124 may apply a set of per-pixel kernels generated by the trained denoising module from a given component group to pixel values from a corresponding component of the frame to be denoised to generate a denoised component associated with the component group.

In step 412, execution engine 124 combines the denoised components associated with the frame into a denoised frame. For example, execution engine 124 may generate the denoised frame as a sum and/or another aggregation of the denoised components generated in step 410.

In step 414, execution engine 124 determines whether or not to continue denoising frames. For example, execution engine 124 may determine that denoising of frames is to continue while additional noisy frames that are temporally related to the recently denoised frame do not have denoised and/or clean counterparts. While execution engine 124 determines that denoising of frames is to continue, execution engine 124 repeats steps 404, 406, 408, 410, and 412 to denoise each frame. During step 404, execution engine 124 may reuse learned components for frames that are shared across sequences instead of computing the learned components for all frames in each sequence. Execution engine 124 may also, or instead, quantize learned components, kernels, and/or other data that is used across denoising passes for individual frames and/or subsets of individual frames to reduce memory consumption associated with the temporal compositional denoising process. After execution engine 124 determines in step 412 that denoising of frames is not to be continued, execution engine 124 may assemble the denoised frames generated in step 412 into a video.

In sum, the disclosed techniques perform temporal compositional denoising of video frames. Each frame from a sequence of temporally related frames is converted by a decomposition module into multiple learned components that are easier to denoise. Learned components for all frames in the sequence are grouped according to a corresponding type and/or index and warped using motion vectors between a frame to be denoised in the sequence and additional frames in the sequence. A denoising module uses each group of components to generate denoising kernels for a component associated with the frame to be denoised. The denoising kernels are applied to pixels in the component to generate a corresponding denoised component associated with the group. Multiple denoised components that are generated using multiple sets of denoising kernels from the denoising module and multiple corresponding components of the frame to denoised are then combined into a denoised version of the frame.

One technical advantage of the disclosed techniques relative to the prior art is the ability to denoise video sequences in a way that leverages temporal information across frames. Consequently, the disclosed techniques reduce flickering and artifacts in denoised video content, compared with conventional techniques that perform denoising of individual frames and/or perform denoising in a non-compositional manner. Another technical advantage of the disclosed techniques is a reduction in resource consumption and/or runtime through the use of optimization techniques that cache and reuse previously computed learned components during denoising of additional frames and/or quantize cached data that is used across rendering passes. Accordingly, the disclosed techniques improve the usability of the temporal compositional denoising process in real-world and/or resource-constrained applications without sacrificing the quality of the denoised video. These technical advantages provide one or more technological improvements over prior art approaches.

1. In some embodiments, a computer-implemented method for denoising video content comprises converting a first frame into a first set of learned components; converting one or more frames that are temporally related to the first frame into one or more additional sets of learned components; and generating, via a first machine learning model, a denoised frame corresponding to the first frame based on the first set of learned components and the one or more additional sets of learned components.

2. The computer-implemented method of clause 1, wherein generating the denoised frame comprises generating a plurality of component groups from the first set of learned components and the one or more additional sets of learned components, wherein each component group included in the plurality of component groups includes a learned component from each of the first set of learned components and the one or more additional sets of learned components; for each component group included in the plurality of component groups generating, via a denoising module included in the first machine learning model, a set of denoising kernels based on the learned components included in the component group; and applying the set of denoising kernels to at least a portion of the learned components included in the component group to generate a denoised component associated with the component group; and combining the denoised components associated with the plurality of component groups into the denoised frame.

3. The computer-implemented method of any of clauses 1-2, wherein generating the plurality of component groups comprises determining motion vectors between the first frame and each of the one or more frames; and warping one or more learned components included in each of the plurality of component groups based on the motion vectors.

4. The computer-implemented method of any of clauses 1-3, wherein generating the set of denoising kernels comprises quantizing at least one of the set of denoising kernels or the learned components based on a set of minimum values and a set of maximum values included in the set of denoising kernels and the learned components.

5. The computer-implemented method of any of clauses 1-4, further comprising generating, via the first machine learning model, a second denoised frame corresponding to a second frame included in the one or more frames based on at least a portion of the first set of learned components and the one or more additional sets of learned components.

6. The computer-implemented method of any of clauses 1-5, wherein converting the first frame into the first set of learned components comprises inputting a set of data associated with the first frame into a second machine learning model; and generating, via execution of the second machine learning model based on the inputted set of data, the first set of learned components.

7. The computer-implemented method of any of clauses 1-6, wherein the set of data comprises at least one of a set of pixel values, an albedo map, a depth map, a variance estimate, or a normal map.

8. The computer-implemented method of any of clauses 1-7, wherein at least one component included in the first set of learned components and the one or more additional sets of learned components comprises at least one of a color image, a mask, and a set of learned features.

9. The computer-implemented method of any of clauses 1-8, wherein the first machine learning model comprises a U-Net.

10. The computer-implemented method of any of clauses 1-9, wherein the one or more frames comprise at least one of a frame that precedes the first frame within a video and a frame that follows the first frame within the video.

11. In some embodiments, one or more non-transitory computer-readable media store instructions that, when executed by one or more processors, cause the one or more processors to perform the steps of converting a first frame into a first set of learned components; converting one or more frames that are temporally related to the first frame into one or more additional sets of learned components; and generating, via a first machine learning model, a denoised frame corresponding to the first frame based on the first set of learned components and the one or more additional sets of learned components.

12. The one or more non-transitory computer-readable media of clause 11, wherein the instructions further cause the one or more processors to perform the step of training the first machine learning model based on one or more losses computed between the denoised frame and a ground truth denoised frame corresponding to the first frame.

13. The one or more non-transitory computer-readable media of any of clauses 11-12, wherein generating the denoised frame comprises performing a plurality of execution passes using the first machine learning model, the first set of learned components, and the one or more additional sets of learned components to generate a plurality of denoised versions of the denoised frame; and combining the plurality of denoised versions into a final version of the denoised frame.

14. The one or more non-transitory computer-readable media of any of clauses 11-13, wherein the plurality of denoised versions is associated with at least one of diffuse component, a specular component, or a transparency component.

15. The one or more non-transitory computer-readable media of any of clauses 11-14, wherein generating the denoised frame comprises generating a plurality of component groups from the first set of learned components and the one or more additional sets of learned components, wherein each component group included in the plurality of component groups includes a learned component from each of the first set of learned components and the one or more additional sets of learned components; for each component group included in the plurality of component groups generating, via a denoising module included in the first machine learning model, a set of denoising kernels based on the learned components included in the component group; and applying the set of denoising kernels to at least a portion of the learned components included in the component group to generate a denoised component associated with the component group; and generating the denoised frame based on a sum of the denoised components associated with the plurality of component groups.

16. The one or more non-transitory computer-readable media of any of clauses 11-15, wherein generating the set of denoising kernels comprises quantizing each channel associated with at least one of the set of denoising kernels or the learned components based on a set of minimum values and a set of maximum values included in the channel.

17. The one or more non-transitory computer-readable media of any of clauses 11-16, wherein the first machine learning model comprises a different denoising module for each component group included in the plurality of component groups.

18. The one or more non-transitory computer-readable media of any of clauses 11-17, wherein converting the first frame into the first set of learned components comprises performing an initial decomposition of the first frame into a first subset of the first set of learned components; and performing an additional decomposition of the first subset of the first set of learned components into a second subset of the first set of learned components.

19. The one or more non-transitory computer-readable media of any of clauses 11-18, wherein the initial decomposition and the additional decomposition are performed via a second machine learning model with a U-Net architecture.

20. In some embodiments, a system comprises one or more memories that store instructions, and one or more processors that are coupled to the one or more memories and, when executing the instructions, are configured to perform the steps of converting a first frame into a first set of learned components; converting one or more frames that are temporally related to the first frame into one or more additional sets of learned components; and generating, via a first machine learning model, a denoised frame corresponding to the first frame based on the first set of learned components and the one or more additional sets of learned components.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for denoising video content, the method comprising:
converting a first frame into a first set of learned components;
converting one or more frames that are temporally related to the first frame into one or more additional sets of learned components; and
generating, via a first machine learning model, a denoised frame corresponding to the first frame based on the first set of learned components and the one or more additional sets of learned components.

2. The computer-implemented method of claim 1, wherein generating the denoised frame comprises:
generating a plurality of component groups from the first set of learned components and the one or more additional sets of learned components, wherein each component group included in the plurality of component groups includes a learned component from each of the first set of learned components and the one or more additional sets of learned components;
for each component group included in the plurality of component groups:
generating, via a denoising module included in the first machine learning model, a set of denoising kernels based on the learned components included in the component group; and
applying the set of denoising kernels to at least a portion of the learned components included in the component group to generate a denoised component associated with the component group; and
combining the denoised components associated with the plurality of component groups into the denoised frame.

3. The computer-implemented method of claim 2, wherein generating the plurality of component groups comprises:
determining motion vectors between the first frame and each of the one or more frames; and
warping one or more learned components included in each of the plurality of component groups based on the motion vectors.

4. The computer-implemented method of claim 2, wherein generating the set of denoising kernels comprises quantizing at least one of the set of denoising kernels or the learned components based on a set of minimum values and a set of maximum values included in the set of denoising kernels and the learned components.

5. The computer-implemented method of claim 1, further comprising generating, via the first machine learning model, a second denoised frame corresponding to a second frame included in the one or more frames based on at least a portion of the first set of learned components and the one or more additional sets of learned components.

6. The computer-implemented method of claim 1, wherein converting the first frame into the first set of learned components comprises:
inputting a set of data associated with the first frame into a second machine learning model; and
generating, via execution of the second machine learning model based on the inputted set of data, the first set of learned components.

7. The computer-implemented method of claim 6, wherein the set of data comprises at least one of a set of pixel values, an albedo map, a depth map, a variance estimate, or a normal map.

8. The computer-implemented method of claim 1, wherein at least one component included in the first set of learned components and the one or more additional sets of learned components comprises at least one of a color image, a mask, and a set of learned features.

9. The computer-implemented method of claim 1, wherein the first machine learning model comprises a U-Net.

10. The computer-implemented method of claim 1, wherein the one or more frames comprise at least one of a frame that precedes the first frame within a video and a frame that follows the first frame within the video.

11. One or more non-transitory computer-readable media storing instructions that, when executed by one or more processors, cause the one or more processors to perform the steps of:
converting a first frame into a first set of learned components;
converting one or more frames that are temporally related to the first frame into one or more additional sets of learned components; and
generating, via a first machine learning model, a denoised frame corresponding to the first frame based on the first set of learned components and the one or more additional sets of learned components.

12. The one or more non-transitory computer-readable media of claim 11, wherein the instructions further cause the one or more processors to perform the step of training the first machine learning model based on one or more losses computed between the denoised frame and a ground truth denoised frame corresponding to the first frame.

13. The one or more non-transitory computer-readable media of claim 11, wherein generating the denoised frame comprises:
performing a plurality of execution passes using the first machine learning model, the first set of learned components, and the one or more additional sets of learned components to generate a plurality of denoised versions of the denoised frame; and
combining the plurality of denoised versions into a final version of the denoised frame.

14. The one or more non-transitory computer-readable media of claim 13, wherein the plurality of denoised versions is associated with at least one of diffuse component, a specular component, or a transparency component.

15. The one or more non-transitory computer-readable media of claim 11, wherein generating the denoised frame comprises:
generating a plurality of component groups from the first set of learned components and the one or more additional sets of learned components, wherein each component group included in the plurality of component groups includes a learned component from each of the first set of learned components and the one or more additional sets of learned components;
for each component group included in the plurality of component groups:
generating, via a denoising module included in the first machine learning model, a set of denoising kernels based on the learned components included in the component group; and
applying the set of denoising kernels to at least a portion of the learned components included in the component group to generate a denoised component associated with the component group; and
generating the denoised frame based on a sum of the denoised components associated with the plurality of component groups.

16. The one or more non-transitory computer-readable media of claim 15, wherein generating the set of denoising kernels comprises quantizing each channel associated with at least one of the set of denoising kernels or the learned components based on a set of minimum values and a set of maximum values included in the channel.

17. The one or more non-transitory computer-readable media of claim 15, wherein the first machine learning model comprises a different denoising module for each component group included in the plurality of component groups.

18. The one or more non-transitory computer-readable media of claim 11, wherein converting the first frame into the first set of learned components comprises:
performing an initial decomposition of the first frame into a first subset of the first set of learned components; and
performing an additional decomposition of the first subset of the first set of learned components into a second subset of the first set of learned components.

19. The one or more non-transitory computer-readable media of claim 18, wherein the initial decomposition and the additional decomposition are performed via a second machine learning model with a U-Net architecture.

20. A system, comprising:
one or more memories that store instructions, and
one or more processors that are coupled to the one or more memories and, when executing the instructions, are configured to perform the steps of:
converting a first frame into a first set of learned components;
converting one or more frames that are temporally related to the first frame into one or more additional sets of learned components; and
generating, via a first machine learning model, a denoised frame corresponding to the first frame based on the first set of learned components and the one or more additional sets of learned components.
